(19) United States
(12) Patent Application Publication
(10) Pub. No.: US 2025/0139625 A1
(43) Pub. Date: May 1, 2025

(54) SECURE DATA TRANSFORMATION AND MERGING SYSTEM

(71) Applicant: Chime Financial, Inc., San Francisco, CA (US)

(72) Inventors: Michael Coughlin, Vancouver (CA); Siddharth Taduri, Burlingame, CA (US); Saurabh Gupta, Oakland, CA (US); Kai Wang, Sunnyvale, CA (US)

(21) Appl. No.: 18/516,545

(22) Filed: Nov. 21, 2023

Related U.S. Application Data
(60) Provisional application No. 63/594,241, filed on Oct. 30, 2023.

(51) Int. Cl. G06Q 20/40; G06F 21/62; G06Q 20/02

(52) U.S. Cl. CPC G06Q 20/4014; G06F 21/6209; G06Q 20/02

(57) ABSTRACT

The disclosure describes embodiments of systems, methods, and non-transitory computer readable storage media that securely generates an unscrubbed Metro2 file. In particular, the disclosed systems can receive data from multiple data sources that relates to a user account. In some cases, the disclosed systems can merge the data related to the user account by utilizing a transformation framework to generate a data staging table. In one or more embodiments, the disclosed systems, based on the data stagging table can generate a scrubbed Metro2 file that does not include personal identification information. In some cases, the disclosed systems can validate the scrubbed Metro2 file by analyzing the data related to the user account. Subsequently, in some instances, based on validating the scrubbed Metro2 file, the disclosed systems can add the personal identification information to the scrubbed Metro2 file and generate an unscrubbed Metro2 file.

### CROSS-REFERENCE TO RELATED APPLICATIONS

This application claims the benefit of and priority to U.S. Provisional Patent Application No. 63/594,241, filed on Oct. 30, 2023. The aforementioned application is hereby incorporated by reference in its entirety.

### BACKGROUND

Recent years have seen an increasing number of systems that utilize specialized reporting software to send consumer credit information to credit bureaus. For instance, many conventional systems utilize specialized software to collect, format, validate, and submit credit information in the correct format to credit bureaus. Although many conventional systems provide consumer credit information to credit bureaus, such conventional systems often face a number of technical shortcomings. Indeed, conventional systems often utilize inefficient and insecure tools to create consumer credit files that comply with Metro2 file formatting.

For instance, conventional systems often utilize inefficient data pipeline frameworks while generating Metro2 files. In particular, many conventional systems facilitate data pipeline job configurations that only operate on (or execute for) a particular data source. Accordingly, in many cases, conventional systems often facilitate the creation and utilization of data pipeline job configurations that are not recognized by multiple data sources while generating Metro2 files. Indeed, such conventional systems cannot adapt their working data pipeline job configuration to another data source without extensive modification to their data pipeline job configurations.

Additionally, many conventional systems utilize insecure methods while generating credit report files according to Metro2 formatting. For instance, some conventional systems collect, store, and move sensitive information throughout their systems while reporting credit information to credit bureaus. By storing and moving sensitive and private information to multiple locations, existing systems increase the likelihood of exposing sensitive information to external entities via data breaches or other unauthorized access by bad actors.

### SUMMARY

The disclosure describes one or more embodiments of systems, methods, and non-transitory computer readable media that securely, accurately, and efficiently generate Metro2 files. In particular, the disclosed systems can facilitate a transformation framework and data pipeline that collects relevant information from various data sources and generates an accurate Metro2 file for credit reporting. For instance, the disclosed systems can generate an accurate Metro2 file by utilizing the transformation framework to efficiently unite relevant information from different content sources in different formats.

In particular, the disclosed systems can receive data related to a user account of an inter-network facilitation system 104 from one or more data sources. Upon receiving the data, the disclosed systems can generate a data staging table by merging the data. Based on the data staging table, the disclosed systems can generate a scrubbed Metro2 file that includes data related to the user account while excluding personal identification information. Subsequently, the disclosed systems can validate the data within the scrubbed Metro2 file and based on the validating the scrubbed Metro2 file, generate an unscrubbed Metro2 file by adding the personal identification information to the scrubbed Metro2 file.

### BRIEF DESCRIPTION OF THE DRAWINGS

The detailed description is described with reference to the accompanying drawings in which:

FIG. 1 illustrates a schematic diagram of an environment for implementing an inter-network facilitation system and a data merging system in accordance with one or more implementations.

FIG. 2 illustrates an overview of a data merging system generating an unscrubbed Metro2 file in accordance with one or more implementations.

FIG. 3 illustrates the data merging system generating a unscrubbed Metro2 file in accordance with one or more implementations.

FIG. 4 illustrates a data merging system utilizing a data pipeline job configuration in accordance with one or more implementations.

FIG. 5 illustrates the data merging system generating a data staging table in accordance with one or more implementations.

FIG. 6 illustrates a data merging system generating a CVS file corresponding to a data staging table in accordance with one or more implementations.

FIG. 7 illustrates a data merging system determining the report status associated with an authorized transaction in accordance with one or more implementations.

FIG. 8 illustrates a portion of an unscrubbed Metro2 file in accordance with one or more embodiments.

FIG. 9 illustrates a flowchart of series of acts for generating an unscrubbed Metro2 file in accordance with one or more embodiments.

FIG. 10 illustrates a block diagram of an exemplary computing device in accordance with one or more implementations.

FIG. 11 illustrates an example environment for an inter-network facilitation system in accordance with one or more implementations.

### DETAILED DESCRIPTION

The disclosure describes one or more embodiments of a data merging system that enables efficient, accurate, and secure generation of Metro2 files. Specifically, the data merging system can receive data from multiple data sources related to a user account. Moreover, the data merging system can generate a data staging table by merging the data related to the user account. In particular, the data merging system can merge the data from the various data sources by utilizing a transformation framework. Subsequently, based on the data staging table, the data merging system can generate a scrubbed Metro2 file that includes data related to the user account and excludes personal identification information. The data merging system can validate the data in the scrubbed Metro2 file and based upon validation, generate an unscrubbed Metro2 file that includes personal identification information.

In one or more embodiments, the data merging system can receive data related to a user account of an inter-network facilitation system. For example, the data merging system can request specific data from one or more data sources (e.g., an online and/or offline data storage services). For instance, in some cases, the data source can be the inter-network facilitation system itself. Alternatively, in some embodiments, the data merging system can receive the data related to the user account from a third-party data source. In some embodiments, once the data merging system receives the data related to the user account, the data merging system can store the data in a database within the inter-network facilitation system.

Once the system receives the data related to the user account, the data merging system can merge the data utilizing a transformation framework. More specifically, the data merging system can generate a data staging table comprising the data related to the user account that, according to regulations and laws, must be reported in a Metro2 file. For example, the data staging table can include financial information (e.g., credit balances and payments, payment history, delinquencies, etc.) that regulatory agencies require to be included in the Metro2 file. In one or more embodiments, the data merging system can generate base tables representing information from the data sources and generate a set of data frames that represent an aspect of the user account from the base tables. In particular, the data merging system can generate the data staging table by merging the set of data frames. In one or more embodiments, the data merging system can merge the set data frames according to a predefined order of steps.

Subsequently, the data merging system can generate a scrubbed Metro2 file. In particular, the data merging system can convert the format of the data staging table into the Metro 2 format. Moreover, the scrubbed Metro2 file can include the necessary information related to the user account while excluding personal identification information. For example, the scrubbed Metro2 file can include a user's payment history and account activity while excluding a user's social security number (SSN). In some embodiments, the data merging system can replace personal identification information with a personal reference number (PRN) token.

Once the data merging system generates the scrubbed Metro 2 file, the data merging system can validate the information in the scrubbed Metro2 file. In particular, the data merging system can apply a set of validation scripts and/or queries ensuring the accuracy of the data related to the user account in the Metro2 file.

Subsequently, the data merging system can generate an unscrubbed Metro2 file after validation. More specifically, based on the validating the data in the scrubbed Metro2 file, the data merging system can add personal identification information to the scrubbed Metro2 file. For instance, the data merging system can replace a social security number (SSN) token with the SSN associated with the user account.

The data merging system can provide numerous technical advantages, benefits, and practical applications relative to conventional systems. To illustrate, unlike conventional systems that are vulnerable to sharing sensitive information while storing, transferring, and compositing data related to user accounts. the data merging system can add sensitive information to the scrubbed Metro2 file in a manner that protects sensitive information. For example, the data merging system reduces the number of instances of sensitive information by generating, storing, and processing a scrubbed (e.g., sanitized) Metro2 file that does not include sensitive information (e.g., personal identification information). The data merging system can further process the scrubbed Metro2 file and eventually add sensitive information to the scrubbed Metro2 file within a secure system prior to reporting to one or more credit bureaus. Thus, by reducing the footprint of sensitive information during generation of an unscrubbed Metro2 file, the data merging system protects sensitive information from bad actors or unauthorized exposure.

Additionally, unlike some conventional systems that utilize data pipeline configurations that cannot handle data from different data sources, the data merging system 106 can utilize a transformation framework that allows the data merging system 106 to smoothly and efficiently pull data from different data sources. For example, the transformation framework can map request(s) from data merging system 106 to native code command(s) that are recognizable by the data source. personal identification information

As indicated by the foregoing discussion, the present disclosure utilizes a variety of terms to describe features and advantages of the data merging system. As used herein, the term “data staging table” refers to a storage structure that aids in the process of data integration. For instance, the data staging table can include data extracted, transformed, loaded, and/or merged from one or more data sources. For example, the data staging table can be a temporary data table that includes data and/or information from one or more data sources related to the user account that is relevant to the Metro2 file. In some cases, the data staging table can include a set of columns that map 1:1 to fields in a Metro2 file.

As further used herein, the term “Metro2 file” refers to a data record reflecting financial information about a user. For instance, the Metro2 file can include the credit history information of a user that is reported to major credit bureaus (e.g., TransUnion, Equifax, and Experian). In one or more embodiments, the Metro2 file conforms to a standardized Metro2 format. For instance, the Metro2 file follows the requirements of the Fair Credit Billing Act (FCBA), the Fair Credit Reporting Act (FRCA), the Equal Credit Opportunity Act (ECOA) and/or state laws. The Metro2 file can comprise a single line of data for each user account made up of several segments (e.g., Header, Base, J1, J2, K1, and Trailer Record) that credit bureaus utilize to determine credit scores and other financial metrics.

Relatedly, as used herein, the term “scrubbed Metro2 file” refers to a Metro2 file that includes data related to the user of a user account while excluding personal identification information. For instance, the scrubbed Metro2 file can include the credit history of the user and replace the social security number of a user with a social security number token. Moreover, as used herein, the term “unscrubbed Metro2 file” refers to a Metro2 file that includes the personal identification information of the user associated with the user account along with the account status, account type, etc. of the user. For instance, the unscrubbed Metro2 file can include a social security number of the user and the credit history of the user. In some embodiments, the data merging system encrypts the unscrubbed Metro2 file after adding the personal identification information.

As used herein, the term “user account” refers to a financial account associated with a user. In some implementations, the user account corresponds to a tradeline that describes credit accounts that can be listed on a credit report. For example, in one or more cases, the user account (e.g., tradeline) can be a revolving trade line (e.g., credit cards or lines of credit), installment tradeline (e.g., mortgages, auto loans, student loans, or personal loans), or open account (e.g., accounts paid in full when a buyer pays a customer). In some cases, the user account can be a secured credit account (e.g., secured credit card) where the credit limit of the secured credit account is a predetermined balance that can be automatically transferred from a checking or savings account and held in the secured credit account. In some embodiments, once the secured credit account hits the predetermined balance, the user cannot make further transactions on the secured credit account. In some embodiments, the data merging system can automatically pay off the balance of the secured credit account with the predetermined balance money held in the secured credit account.

As further used herein, the term “data source” refers to a service or repository (e.g., via hardware and/or software) that manages data (e.g., storage of data, access to data, collection of data). In some cases, a data source refers to a data service or data repository (e.g., via hardware and/or software) that manages data storage via cloud-based services and/or other networks (e.g., offline data stores, online data stores). To illustrate, a data source can include, but is not limited to, cloud computing-based data storage and/or local storage. In some cases, a data source can correspond to various cloud-based data service companies that facilitate the storage, movement, and access to data. For example, a data source can be a financial institution that stores banking information, personal data, credit history details, etc.

In addition, as used herein, the term “data source request” (or sometimes referred to as “request”) refers to an instruction for a data source. In some cases, a data source request can include instructions (or queries) to read from (and/or access) a data source (e.g., select data, export data), create a matrix, write data to a data source (e.g., update data, delete data, insert into data, create database, create table, upload data), update and/or add permissions for the data source, and/or update and/or add settings for the data source. Indeed, the data merging system can receive data source requests as a set of instructions for a data pipeline job represented in a programming paradigm.

Moreover, as used herein, the term “transformation framework” refers to a system that processes and converts data from one format and/or structure into another format and/or structure. For instance, the data merging system can use the transformation framework to connect to and extract data from various data sources (e.g., databases, APIs, etc.), data tables, and data systems. For example, the transformation framework can extract data from one or more data sources by performing a series of queries, following a set of predefined rules, or utilizing data connectors. Once extracted, the data merging system can utilize the transformation framework to generate the data staging table by cleansing, validating, transforming, and merging the necessary data.

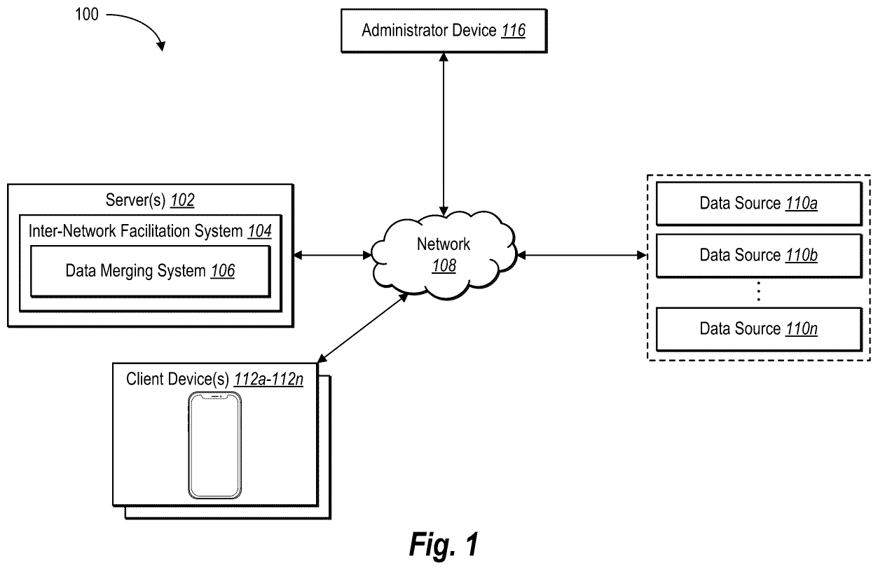

Turning now to the figures, FIG. 1 illustrates a block diagram of a system 100 (or system environment) for implementing an inter-network facilitation system 104 and a data merging system 106 in accordance with one or more embodiments. As shown in FIG. 1, the system 100 includes server device(s) 102 (which includes the inter-network facilitation system 104 and the data merging system 106), data source(s) 110a-110n, client device(s) 112a-112n, and an administrator device 116. As further illustrated in FIG. 1, the server device(s) 102, the data sources 110a-110n, the client device(s) 112a-112n, and the administrator device 116 can communicate via the network 108.

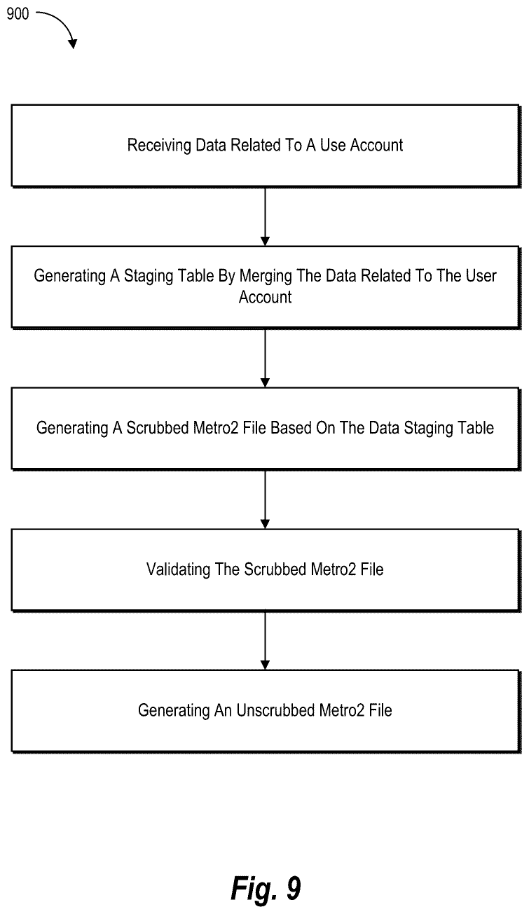

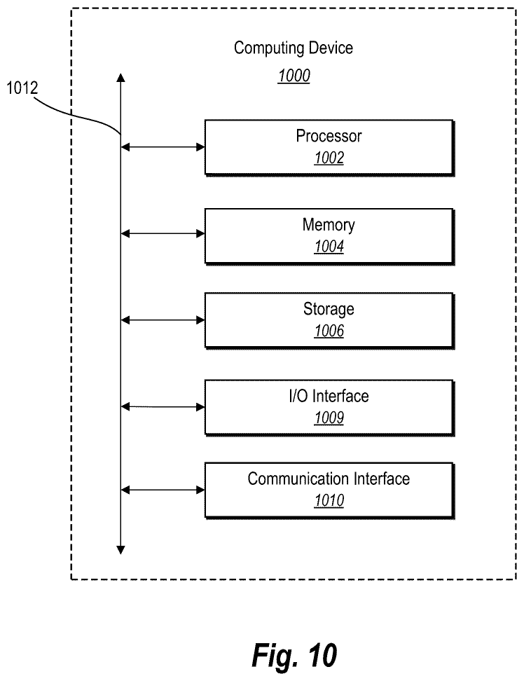

Although FIG. 1 illustrates the data merging system 106 being implemented by a particular component and/or device within the system 100, the data merging system 106 can be implemented, in whole or in part, by other computing devices and/or components in the system 100 (e.g., the client device(s) 112a-112n). Additional description regarding the illustrated computing devices (e.g., the server device(s) 102, computing devices implementing the data merging system 106, the data sources 110a-110n, the client device(s) 112a-112n, the administrator device 116, and/or the network 108) is provided with respect to FIGS. 9 and 10 below.

As shown in FIG. 1, the server device(s) 102 can include the inter-network facilitation system 104. In some embodiments, the inter-network facilitation system 104 can determine, store, generate, and/or display financial information corresponding to a user account (e.g., a banking application, a money transfer application, a credit card account). Furthermore, the inter-network facilitation system 104 can also electronically communicate (or facilitate) financial transactions between one or more user accounts (and/or computing devices). Moreover, the inter-network facilitation system 104 can also track and/or monitor financial transactions and/or financial transaction behaviors of a user within a user account.

The inter-network facilitation system 104 can include a system that comprises the data merging system 106 and that facilitates financial transactions and digital communications across different computing systems over one or more networks. For example, an inter-network facilitation system manages credit accounts, secured accounts, and other accounts for one or more accounts registered within the inter-network facilitation system 104. In some cases, the inter-network facilitation system 104 is a centralized network system that facilitates access to online banking accounts, credit accounts, and other accounts within a central network location. Indeed, the inter-network facilitation system 104 can link accounts from different network-based financial institutions to provide information regarding, and management tools for, the different accounts.

In one or more embodiments, the data merging system 106 enables dynamic utilization of a unified request format within a data pipeline job configuration that can interact with a variety of data sources (e.g., data sources 110a-110n) having different (or dissimilar) native code commands. For instance, the data merging system 106 can receive a data source request from the administrator device 116. Then, the data merging system 106 can utilize the transformation framework to generate a data staging table with all of the necessary information.

Furthermore, as shown in FIG. 1, the system 100 includes the data sources 110a-110n. For example, the data sources 110a-110n can manage and/or store various data for the inter-network facilitation system 104, the client device(s) 112a-112n, and/or the administrator device 116. As mentioned above, the data sources 110a-110n can include various data services or data repositories (e.g., via hardware and/or software) that manage data storage via cloud-based services and/or other networks (e.g., offline data stores, online data stores). In some instances, the data sources can come from third-party systems.

As also illustrated in FIG. 1, the system 100 includes the client device(s) 112a-112n. For example, the client device(s) 112a-112n may include, but are not limited to, mobile devices (e.g., smartphones, tablets) or other type of computing devices, including those explained below with reference to FIGS. 9 and 10. Additionally, the client device(s) 112a-112n can include computing devices associated with (and/or operated by) user accounts for the inter-network facilitation system 104. Moreover, the system 100 can include various numbers of client devices that communicate and/or interact with the inter-network facilitation system 104 and/or the data merging system 106.

Furthermore, the client device(s) 112a-112n can include the client application(s). The client application(s) can include instructions that (upon execution) cause the client device(s) 112a-112n to perform various actions. For example, a user of a user account can interact with the client application(s) on the client device(s) 112a-112n to access financial information, initiate a financial transaction (e.g., transfer money to another account, deposit money, withdraw money), and/or access or provide data (to the data sources 110a-110n or the server device(s) 102).

In certain instances, the client device(s) 112a-112n corresponds to one or more user accounts (e.g., user accounts stored at the server device(s) 102). For instance, a user of a client device can establish a user account with login credentials and various information corresponding to the user. In addition, the user accounts can include a variety of information regarding financial information and/or financial transaction information for users (e.g., name, telephone number, address, bank account number, credit amount, debt amount, financial asset amount), payment information (e.g., account numbers), transaction history information, and/or contacts for financial transactions. In some embodiments, a user account can be accessed via multiple devices (e.g., multiple client devices) when authorized and authenticated to access the user account within the multiple devices.

The present disclosure utilizes client devices to refer to devices associated with such user accounts. In referring to a client (or user) device, the disclosure and the claims are not limited to communications with a specific device, but any device corresponding to a user account of a particular user. Accordingly, in using the term client device, this disclosure can refer to any computing device corresponding to a user account of the inter-network facilitation system 104.

Additionally, as shown in FIG. 1, the system 100 also includes the administrator device 116. In certain instances, the administrator device 116 may include, but is not limited to, a mobile device (e.g., smartphone, tablet) or other type of computing device, including those explained below with reference to FIGS. 9 and 10. Additionally, the administrator device 116 can include a computing device associated with (and/or operated by) an administrator for the inter-network facilitation system 104. Moreover, the system 100 can include various numbers of administrator devices that communicate and/or interact with the inter-network facilitation system 104 and/or the data merging system 106. Indeed, the administrator device 116 can access data generated (or transformed) by one or more data pipelines running on the data merging system 106 and/or data of the data sources 110a-110n.

As further shown in FIG. 1, the system 100 includes the network 108. As mentioned above, the network 108 can enable communication between components of the system 100. In one or more embodiments, the network 108 may include a suitable network and may communicate using a various number of communication platforms and technologies suitable for transmitting data and/or communication signals, examples of which are described with reference to FIG. 10. Furthermore, although FIG. 1 illustrates the server device(s) 102, the client devices 112a-112n, the data sources 110a-110n, and the administrator device 116 communicating via the network 108, the various components of the system 100 can communicate and/or interact via other methods (e.g., the server device(s) 102 and the client devices 110a-110n can communicate directly).

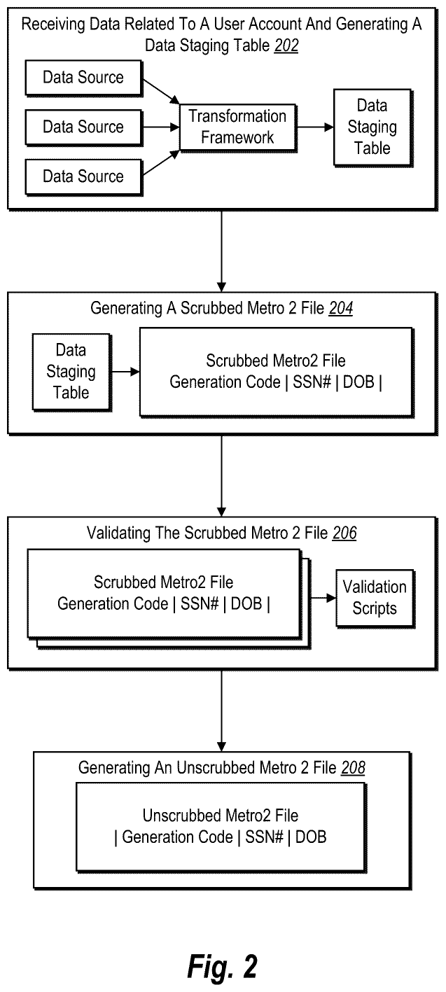

As mentioned above, the data merging system 106 can generate scrubbed and unscrubbed Metro2 files. FIG. 2 illustrates an overview of the data merging system 106 generating an unscrubbed Metro2 file in accordance with one or more embodiments. In particular, as shown in FIG. 2, the data merging system 106 can receive data (e.g., payment history, daily user account balances, etc.) related to a user account and generate a data staging table by merging the data associated with the user account. The data merging system 106 can further generate a scrubbed Metro2 file that conforms to Metro2 formatting regulations while not including personal identification information (e.g., social security numbers, personal reference numbers, taxpayer identification numbers, etc.). The data merging system 106 can validate the scrubbed Metro2 file and based on validating the scrubbed Metro2 file, the data merging system 106 can generate an unscrubbed Metro2 file that includes the personal identification information associated with the user account.

As shown in FIG. 2, the data merging system 106 can perform the act 202 of receiving data related to a user account and generating a data staging table. As discussed above, Metro2 files must follow a specific format and report specific values. In some instances, based on existing knowledge of the data reported in Metro2 files, the data merging system 106 can request and/or extract the required data from one or more data sources. In one or more cases, once the data merging system 106 extracts the relevant data from one or more data sources, the data merging system 106 can merge the relevant data by compiling, combining, and/or transforming the relevant data into a data staging table conforming to Metro2 file requirements utilizing a transformation framework.

As further shown in FIG. 2, the data merging system 106 performs the act 204 of generating a scrubbed Metro2 file. In particular, based on the data and/or information in the data staging table, the data merging system 106 can generate a scrubbed Metro2 file that includes the information from the data staging table while excluding personal identification information associated with the user account. For example, the scrubbed Metro2 file can include all of the required information while excluding the social security number associated with the user account. In some embodiments, the data merging system 106 replaces the social security number associated with the user account with a social security number token.

As further shown in FIG. 2, the data merging system 106 can perform the act 206 of validating the scrubbed Metro2 file. In particular, the data merging system 106 can perform a set of validations queries or scripts on the on scrubbed Metro2 file. For example, the data merging system 106 can compare information in the scrubbed Metro2 file with information in previous Metro2 files associated with the user account. For example, based on the scrubbed Metro2 file aligning with trends from previous Metro2 files, the data merging system 106 can determine that the information in the scrubbed Metro2 file is accurate.

As FIG. 2 further illustrates, the data merging system 106 can perform the act 208 of generating an unscrubbed Metro2 file. More specifically, based on validating the scrubbed Metro2 file (e.g., ensuring the information in the unscrubbed Metro2 file is correct and ready to report), the data merging system 106 can add the personal identification information to the scrubbed Metro2 file. As mentioned above, in some cases, the data merging system 106 can add the personal identification information by replacing the social security token with the social security number associated with the user account.

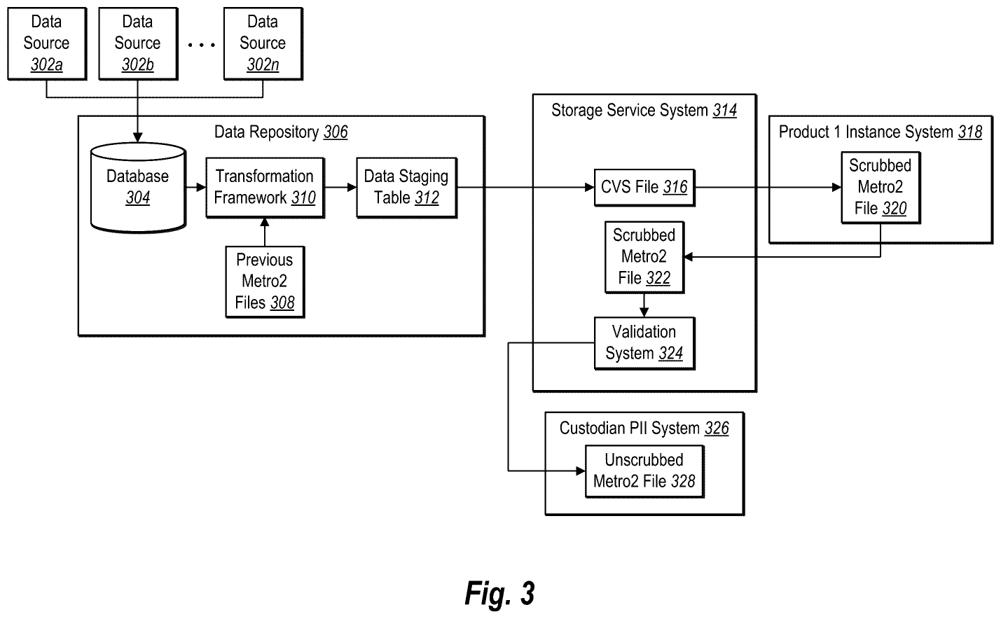

Additionally, FIG. 3 illustrates the data merging system 106 generating an unscrubbed Metro2 file in accordance with one or more embodiments. As shown in FIG. 3, the data merging system 106 via a data transformation pipeline can generate an unscrubbed Metro2 file 328. In some implementations, the data merging system 106 can request data from various data sources 302a-n. For instance, the data merging system 106 can perform a series of queries on one or more data sources 302a-n. In one or more embodiments, based on the required reporting associated with a Metro2 file, the data merging system 106 can pull the required information and/or data by performing specific queries on multiple data sources 302a-n. For example, the data merging system 106 can receive a document reciting a credit limit associated with the user account by performing a credit limit query on credit statements associated with the user account.

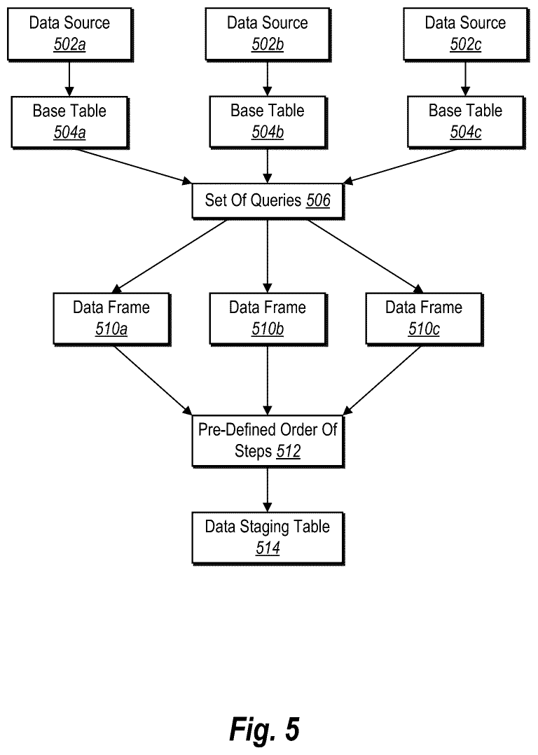

As further shown in FIG. 3, the data merging system 106 can store the data received from the multiple data sources 302a-n in a database 304 within a data repository 306. As described in more detail below in FIG. 5, in some embodiments, the data merging system 106 can generate one or more base tables and data frames from the data stored in the database 304.

As indicated in FIG. 3, in some embodiments, the data merging system 106 can generate a data staging table 312 with a set of columns that map to a Metro2 file. In some implementations, the data merging system 106 can generate the data staging table 312 by utilizing a transformation framework 310 to combine information (e.g., base tables and data frames) from the database 304 and previous Metro2 files 308. For example, the data merging system 106 can process the information in the database 304 and the previous Metro2 files 308 and generate a data staging table that includes all of the relevant data associated with a user account. As mentioned above, the data staging table 312 can include columns that map to the Metro2 file format. In some embodiments, the data staging table 312 can include additional columns providing extra context about the user account. For example, the data staging table can include columns indicating whether the user account should be reported to one or more credit bureaus, the statement period associated with the user account, a reason for excluding the user account from being reported, whether the user account was reopened, etc.

As illustrated in FIG. 3, the data merging system 106 can transmit the data staging table 312 from the data repository 306 to a storage service system 314 (e.g., AWS, Azure, Zadara, IBM Cloud, etc.). Within the storage service system 314, the data merging system 106 can generate an intermediate instance of the scrubbed Metro2 file by converting the data staging table 312 into a comma-separated versions (CVS) file 316 associated with the data staging table 312 within the storage service system 314. In one or more embodiments, the data merging system 106 can transmit the CVS file 316 to a product instance system 318. In some cases, the data merging system 106 can generate a scrubbed Metro2 file 320 from the CVS file 316. For instance, within the product instance system 318, the data merging system 106 can generate the scrubbed Metro2 file 320 by converting the format of the CVS file 316 into the Metro2 format specified by the FCBA, the FRCA, the ECOA, and/or other state laws. For example, the data merging system 106 can apply a programming language and/or code (e.g., Ruby, Java, Python, etc.) that converts the format of the CVS file 316 into Metro2 file format.

As further illustrated in FIG. 3, the data merging system 106 can transmit the scrubbed Metro2 file 320 from the product instance system 318 to the storage service system 314. Within the storage service system 314, the data merging system 106 can validate the information within the scrubbed Metro2 file 320 by utilizing a validation system 324. In particular, the data merging system 106 can perform a series of validation scripts on the Metro2 file. For example, the data merging system 106 can perform a trend script that analyzes trends of previous Metro2 files associated with the user account and determine if the information within the scrubbed Metro2 file 320 aligns with the trends of previous Metro2 files for the user account.

As shown in FIG. 3, once the data merging system 106 validates the information within the scrubbed Metro2 file 320, the data merging system 106 can transmit the scrubbed Metro2 file 320 from the storage service system 314 to the custodian PII system 326. In one or more implementations, based on validating the scrubbed Metro2 file 320, the data merging system 106 can generate an unscrubbed Metro2 file 328 by adding personal identification information. For instance, in some cases, the data merging system 106 can replace the social security number token with the social security number associated with the user account. In one or more embodiments, the data merging system 106 can encrypt a final instance of the unscrubbed Metro2 file 328 and send the encrypted unscrubbed Metro2 file 328 to one or more third-party systems (e.g., credit bureaus).

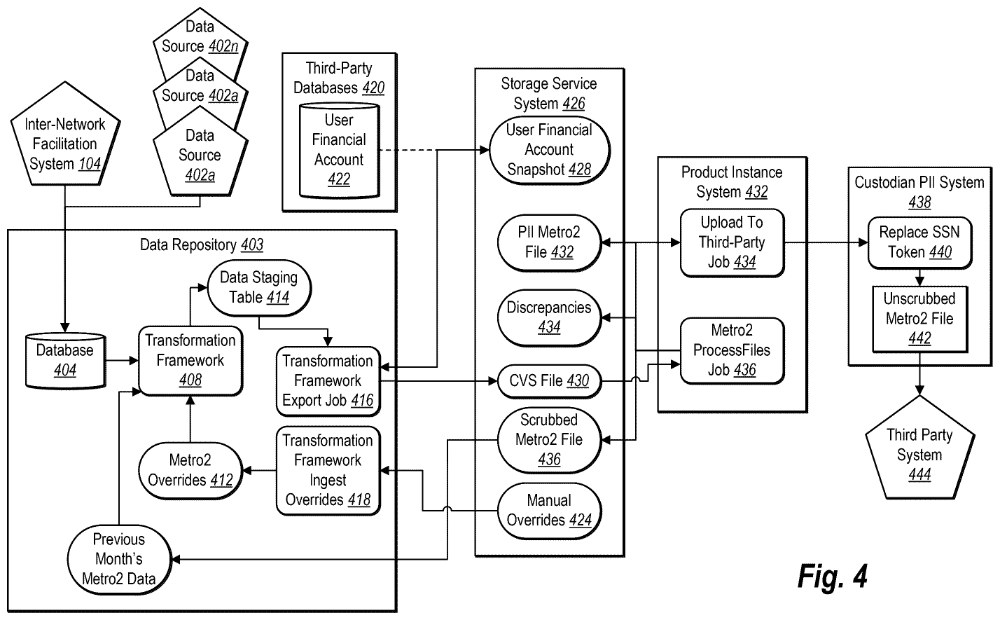

FIG. 4 illustrates a data merging system utilizing a data transformation pipeline configuration in accordance with one or more implementations. As discussed above, the data merging system 106 can receive data from one or more data sources 402a-n. In some embodiments, and as shown in FIG. 4, the data transformation pipeline configuration can start with data merging system 106 receiving data and/or information from the inter-network facilitation system 104 and one or more data sources 402a-n.

As described above, the data merging system 106 can pull data and/or information from the inter-network facilitation system 104 and one or more data sources 402a-n. In particular, the data merging system 106 can receive and store the data from the one or more data sources 402a-n in database 404. As indicated above, the data merging system 106 can generate data staging table 414 by inputting data from the inter-network facilitation system 104 and/or one or more data sources 402a-n into the transformation framework 408.

In one or more implementations, the data merging system 106 can dictate how the transformation framework 408 merges the data from the inter-network facilitation system 104 and one or more data sources 402a-n according to one or more overrides. Generally, an override refers to a mechanism or setting that dictates how the transformation framework formats, converts, filters, enriches, routes, secures, etc. data from the inter-network facilitation system 104 and one or more data sources 404a-n.

For instance, as shown in FIG. 4, the data merging system 106 can receive manual overrides 424 from the storage service system 426 dictating how the transformation framework merges the data from the inter-network facilitation system 104 and one or more data sources 404a-n. In particular, based on receiving the manual overrides 424, the data merging system 106 can load the transformation framework ingest overrides 418 to the data repository 403. In one or more embodiments, based on the manual overrides 424, the transformation framework ingest overrides 418 can dictate how the transformation framework extracts, transforms, converts, filters, and/or enriches the data from the inter-network facilitation system 104 and the one or more data sources 404a-n. In some implementations, from the transformation framework ingest overrides 418, the data merging system 106 can generate Metro2 overrides 412 that extract, transform, convert, filter, and/or enrich the data from the inter-network facilitation system 104 and data sources 402a-n in order to get all of the required information for the unscrubbed Metro2 file 442.

As mentioned above, in one or more cases, the data merging system 106 can merge the data from database 404 and previous Metro2 files 410 utilizing the transformation framework 408 according to the Metro 2 overrides 412. In some embodiments, the data merging system 106 can generate the data staging table 414 with all of the relevant information required for the unscrubbed Metro2 file. For example, the data merging system 106 can generate the data staging table by generating columns with data/information that maps to defined fields in the Metro2 file. For example, the fifth column of the data staging table 414 can include an Equifax identifier that maps to the fifth field in the header section of a Metro2 file that represents the Equifax credit grantor number.

In one or more embodiments, once the data merging system 106 generates the data staging table 414, the data merging system 106 can perform a transformation framework export job 416 that sends the data staging table 414 to a storage service system 426. Within the storage service system 426, the data merging system 106 can generate a CVS file 430 based on the data staging table 414. For example, the data merging system 106 can convert the base table into a CVS file by utilizing programing languages (e.g., python, java, etc.), ETL tools (e.g., Apache Spark), and/or SQL queries.

In one or more embodiments, the data merging system 106 can send the CVS file 430 to the product instance system 433. In one or more implementations, within the product instance system 433, the data merging system 106 can perform a Metro2 process files job 435. In some cases, when the data merging system 106 performs the Metro2 process files job 435, the data merging system 106 can generate a scrubbed Metro2 file 436 and a PII Metro2 file 432. In some cases, the data merging system 106 can identify discrepancies 434 between the CVS file 430 and the scrubbed Metro2 file 436. For example, the data merging system 106 can flag inconsistencies between the scrubbed Metro2 file 436, the CVS file 430, and data staging table 414.

As shown in FIG. 4, in certain implementations, the Metro2 process files job 435 can generate a PII Metro2 file 432. In some cases, the PII Metro2 file 432 can includes some personal identification information associated with the user account. For instance, the PII Metro2 file 432 can include a personal reference number (PRN) associated with the user account while excluding the social security number associated with the user account. In some cases, the PRN is a unique number or combination of numbers and letters that corresponds to the user account and user financial account 422. For example, as shown in FIG. 4, the data merging system 106 can receive from a bank account database 420 within the inter-network facilitation system 104 a PRN associated with a user financial account 422. In one or more embodiments, along with PRN associated with the user account and user financial account 422, the data merging system 106 can receive a user financial account snapshot 428 that provides an overview of transactions, available balances, recent deposits etc. of the user financial account 422.

As further illustrated in FIG. 4, the data merging system 106 can generate a scrubbed Metro2 file 436 from the Metro2 process files job 435. In one or more implementations, the scrubbed Metro2 file does not include personal identification information. For example, in some cases, the scrubbed Metro2 file 436 does not contain the social security number and/or the PRN associated with the user account. For example, the scrubbed Metro2 file 436 could include a social security number token and/or PRN token. As further shown in FIG. 4, in certain implementations, the data merging system 106 can receive the scrubbed Metro2 file 436 from the storage service system 426 within the data repository 403. In some cases, once the scrubbed Metro2 file 436 is in the data repository 403, the data merging system 106 can process and/or analyze the scrubbed Metro2 file 436 for future use. For instance, the data merging system 106 can utilize an airflow job to load the scrubbed Metro2 file 436 in the data repository 403 for future sourcing.

In some embodiments, the data merging system 106 can validate the data within the scrubbed Metro2 file 436. In particular, the data merging system 106 can run a set of validation queries and/or scripts to ensure that the information in the scrubbed Metro2 file 436 is correct and ready to report to a third-party system 444. For example, the data merging system 106 can perform a trend script that tracks month to month trends of Metro2 files. For instance, the data merging system 106 can determine if the data within the scrubbed Metro2 file 436 for a given month aligns with the data from previous months. In some cases, the data merging system 106 can perform a record comparison script on the scrubbed Metro2 file 436. In particular, the data merging system 106 can compare the values in the scrubbed Metro2 file 436 with the values in an additional Metro2 file that is generated by a different approach. Based on the values in the scrubbed Metro2 file matching the values in the additional Metro2 file, the data merging system 106 can validate the accuracy of the data in the unscrubbed Metro2 file 436. Additionally, the data merging system 106 can perform a logic script on the unscrubbed Metro2 file 436. For example, the data merging system 106 can identify a user account with a known report status (e.g., current, delinquent, write off, etc.). The data merging system 106 can input data mirroring the values of the user account into the data transformation pipeline and confirm that the data merging system 106 assigns the same report status as the known report status and other expected values. In some embodiments, the data merging system 106 can generate a validation report for the scrubbed Metro2 file 436 indicating if the data within the scrubbed Metro2 file 436 is correct.

In one or more embodiments, once the data merging system 106 validates the unscrubbed Metro2 file 436, the data merging system 106 can transmit the PII Metro2 file 432 to the product instance system 433. As shown in FIG. 4, within the product instance system 433, the data merging system 106 can trigger an upload to third-party job 437 where the data merging system 106 can send the PII Metro2 file 432 to the custodian PII system 438.

As shown in FIG. 4, the data merging system 106 can generate an unscrubbed Metro2 file 442 within the custodian PII system 438. For example, the data merging system 106 can generate the unscrubbed Metro2 file 442 by replacing the social security number token 440 with the social security number associated with the user account. In one or more implementations, the PII Metro2 file 432 can include a PRN token and the custodian PII system 438 can replace the PRN token with the PRN associated with the user account and/or user financial account 422. In one or more embodiments, the data merging system 106 can transmit the unscrubbed Metro2 file 442 to a third-party system 444. In particular, the data merging system 106 can encrypt the unscrubbed Metro2 file 442 and send the unscrubbed Metro2 file 442 to one or more credit bureaus.

As mentioned above, the data merging system 106 can generate a data staging table that includes all of the data required for that Metro2 reporting. FIG. 5 illustrates an overview of the data merging system generating the data staging table in accordance with one or more implementations. For instance, as shown in FIG. 5, the data merging system 106 can receive data and/or information from one or more data sources 502a-c. In one or more embodiments, the data merging system 106 can create one or more base tables 504a-c that correspond to the one or more data sources 502a-c. As used herein, the term “base table” refers to a table that stores and represents data from a data source in a database. For instance, a base table can store raw data according to a specific format. For example, in some embodiments, the base table can be a relational table, spreadsheet, HTML table, flat file, temporary table, metadata table, etc. For instance, the base table can contain rows and columns of data reflecting the information in from a data source. To further illustrate, the data merging system 106 can pull an account statement from a financial institution database and represent the data in the account statement in base table 504a. In certain implementations, the base tables 504a-c can track segment events, ingested overrides, and/or tables from one or more data sources (e.g., Chime, Galileo, Snowflake tables). In one or more embodiments, the data merging system 106 can generate a base table for each data source 502a-c. For example, as shown in FIG. 5, the data merging system 106 can generate base table 504a that reflects data and/or information from data source 502a, base table 504b that represents data from data source 502b, and base table 504c and includes values from data source 502c. As further shown in FIG. 5, the data merging system 106 can combine and identify relevant data in base tables 504a-c by applying a set of queries 506 on the base tables 504a-c. As used herein, the term “set of queries” refers to a set and/or series of requests for particular information and/or data from one or more datasets (e.g., base tables) or databases. For instance, a set of queries can extract, filter, aggregate, or sort information from one or more data sets. In some embodiments, the data merging system 106 can utilize the set of queries to generate a set of data frames 510a-c that represent one aspect of user account. For example, the data merging system 106 can apply a payment history query on base tables 502a-c and generate a data frame 510a that represents the payment history of the user account.

As mentioned above and further shown in FIG. 5, the data merging system 106 can generate a set of data frames 510a-c. As used herein the term “data frame” refers to a particular data structure that represents and/or stores data related to an aspect of a user account. For example, the data merging system 106 can convert data from a base table into a data frame that reflects a factor (e.g., balances and payments, payment history, account info, etc.) of the user account. As previously indicated, in one or more embodiments, the data merging system 106 can generate one or more data frames 510a-c by performing a set of queries 506 on base tables 504a-c. In some embodiments, the data merging system 106 can reduce and/or aggregate the information in the base tables 504a-c into data frames 510a-c based on the set of queries. For instance, the data merging system 106 can perform a personal identification information query on base tables 504a-c that pull personal identification information (e.g., SSN, home address, date of birth, driver's license number, etc.) from the base tables 504a-c and generate a personal identification information data frame that contains all of the relevant personal identification information associated with the user account.

In one or more cases, the data merging system 106 can combine the set of data frames 510a-c according to a pre-defined order of steps 512. In particular, the data merging system 106 can combine the data frames 510a-b in a manner that accurately and securely includes all of the values, data, and information to be reported in the unscrubbed Metro2 file. For example, the pre-defined order of steps 512 can maintain chronological or logical relationships between the data frames 510a-bc and reporting status of the user account. In one or more cases, the pre-defined order of steps 512 can manage when the data merging system 106 adds sensitive information to the data staging table 514. For example, adding personal identification information at the last step of the pre-defined order of step 512 can reduce the risk of exposing sensitive information to unauthorized individuals or entities. As discussed above and shown in FIG. 5, the data merging system 106 can generate the data staging table 514 by merging data related to the user account.

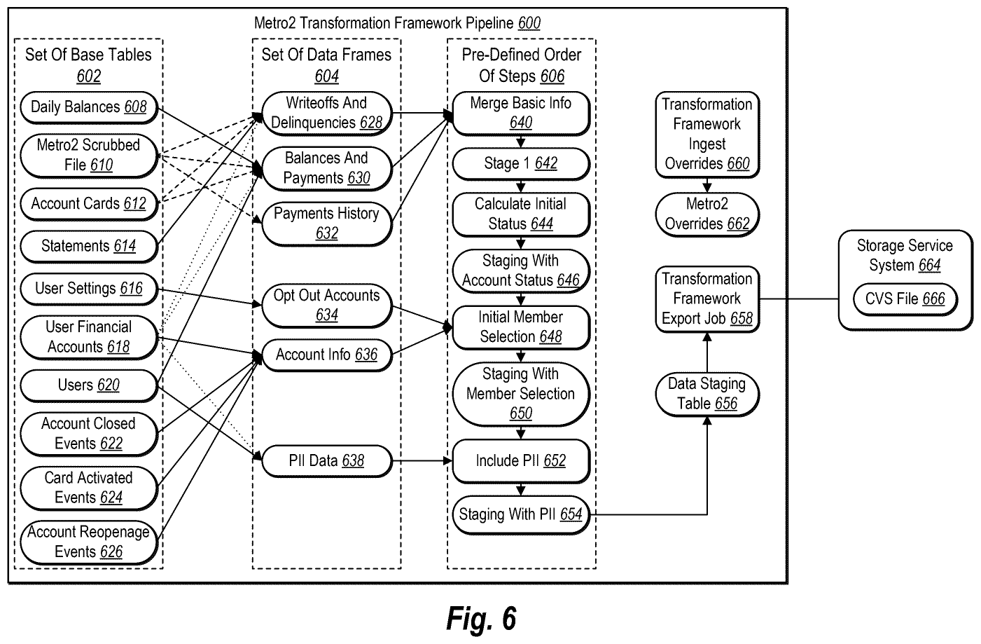

As just discussed, the data merging system 106 can generate a data staging table by merging a set of data frames. FIG. 6 illustrates the data merging system 106 generating a set of data frames and merging the set of data frames 604 according to a predefined order of steps 606 in accordance with one or more embodiments.

For example, FIG. 6 shows a set of base tables 602 as a first layer in the Metro2 transformation framework pipeline 600. The set of base tables 602 can include base tables representing data sources. In one or more embodiments, the set of base tables 602 can include a base table representing daily balances 608 of the user account. For instance, the base table for daily balances 608 can include information about the current balances of the user account and user financial account. In some implementations, the base table for the scrubbed Metro2 file 610 can comprise information from prior scrubbed Metro2 files. For example, the data merging system 106 can generate a base table that with information reported in the unscrubbed Metro2 file of the previous month.

As further illustrated in FIG. 6, the set of base tables 602 can include base table for account cards 612. In some cases, the base table for account cards 612 can reflect the payment amount, highest balance, etc. for one or more account cards (e.g., credit cards) associated with the user account. As FIG. 6 shows, the base table for statements 614 can include data summarizing transactions occurring during a billing period for an account card, financial user account, or user account. In some cases, the data table for user settings 616 can include information about login identification, passwords, transaction alerts, or employment information associated with the user account. In one or more implementations, the base table for user financial accounts 618 can include information about data related to a user financial account. For example, the base table for the user financial accounts can include the balances, account numbers, or transactions for the financial account associated with the user account.

As depicted in FIG. 6, the set of base tables can include a base table for users 620. In one or more embodiments, the base table for users 620 can include user identification, usernames, user mailing addresses, user phone numbers, etc. In some implementations, the base table for account closed events 622 can include the date a user account closed and/or reason why a user account closed. For example, based on receiving an indication that a user associated with the user account passed away, the data merging system 106 can close the user account. As further shown in FIG. 6, a base table for card activated events 624 can indicate the day a card associated with the user account was activated. In some cases, the set of base tables 602 can include a base table for account reopened events 626. For example, if the user account closed and later reopened, the base table for account reopened events 626 can include the reopening date.

As further illustrated in FIG. 6, the data merging system 106 can generate a set of data frames 604 by combining data from one or more base tables from the set of base tables 602. As previously mentioned, the data merging system 106 can generate data frames that represent certain aspects of a user account. For example, the data frame for write offs and delinquencies 628 can include a list of user accounts that are marked as delinquent or written off during the reporting period of the current month. In some embodiments, the data merging system 106 can use the base tables for statements 614, scrubbed Metro2 file 610, and/or account cards 612 to determine the delinquency or write off status of the user account. For example, the data merging system 106 can look at the transaction or payment history within the base table for account cards 612 to determine if the user account is delinquent on debts. In certain implementations, the data merging system 106 can use segment events to determine if the user account is delinquent or associated with any write offs. For example, if a user account does not pay the balance of the user account for thirty days, the data merging system 106 can generate and send an account closed write off segment and/or user account closed payoff to the transformation framework. In some cases, the data frame for write offs and delinquencies 628 can include a user identification associated with the user account and the status (e.g., delinquent, paid off, closed, or open) of the user account. In some embodiments, the data frame for write offs and delinquencies 628 can include the date of the first delinquency of the user account or the original write off amount. In one or more cases, the data merging system 106 can include the reporting period for the unscrubbed Metro2 file.

As illustrated in FIG. 6, the data merging system 106 can generate a data frame for balances and payments 630 associated with the user account. For example, the data frame for balances and payments 630 can aggregate all balance and payment related information for the user accounts (e.g., Metro2 accounts) based on data from base tables for daily balances 608, previous Metro2 files 610, account cards 612, user financial accounts 618, and/or users 620. For example, the data frame of balances and payments 630 can include the current balance of the user account, the highest balance associated with the user account, the amount paid on the user account, and/or the date of last payment on the user account.

As further illustrated in FIG. 6, the data merging system 106 can generate a data frame for payment history 632. The data merging system 106 can generate the data frame for payment history 632 based on the previous unscrubbed Metro2 file. For instance, the payment history of the current month can be a combination of the payment history of the previous month and the report status of the user account during the previous month.

As FIG. 6 shows, the set of data frames 604 can include a data frame for opt out accounts 634. In one or more embodiments, the data frame for opt out accounts can include a list of user accounts that should be excluded from Metro2 file reporting. In some embodiments, the data merging system 106 can receive user input identifying user accounts that will not be reported to one or more third-party systems (e.g., credit bureaus).

In one or more embodiments, the set of data frames 604 can include a data frame for account info 636. In one or more embodiments, the data frame for account info 636 can include information for all user accounts that are eligible for Metro2 reporting for a particular month. For instance, in some embodiments, the data frame for account info 636 can include a user ID for the user account, status (e.g., open, closed, delinquent, reopened) of the user account, and/or a hashed (e.g., encrypted) PRN. Relatedly, the data frame for account info 636 can also include the date the user account opened, the date the user account closed, and/or the data the user account reopened. In some cases, the data frame for account info 636 can include the date of funding the user account. For example, the data merging system 106 can show when the user account receives funds from a linked financial account. As shown in FIG. 6, the data merging system 106 can generate the data frame for account info 636 by combining base tables for user financial accounts 618, account closed events 622, card activated events 624, and/or account reopening events 626.

As shown in FIG. 6, the set of data frames 604 can include a data frame for PII data 638. For instance, PII data can include information that distinguishes one user account from another user account. For example, the data frame for PII data 638 can include login credentials, first and last name, mailing address, phone number, date of birth, email address, driver's license number, social security number, passport number, PRN, credit card number, or debit card number associated with the user account. In one or more cases, the data merging system 106 can generate the data frame for PII data by combining information from base tables for user financial accounts 618 and/or users 620.

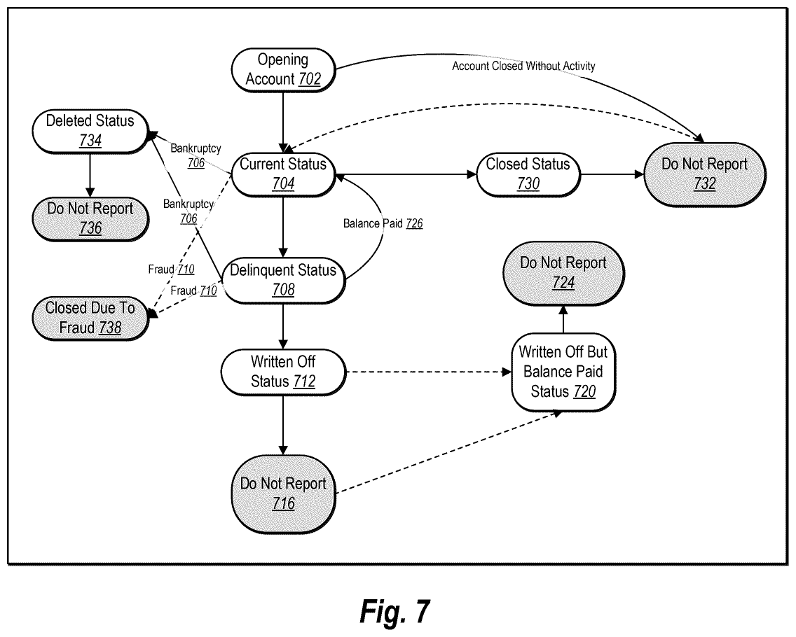

As FIG. 6 further shows, the data merging system 106 can combine the set of data frames 604 according to a predefined order of steps 606. In particular, the data merging system 106 can generate different stages of the data staging table by combining specific data frames. For instance, the data merging system 106 can merge basic information 640 from the data frames for write offs and delinquencies 628, balances and payments 630, and payment history 632 and generate a first stage 642 of the data staging table 656. Based on the first stage 642 of the data staging table 656, the data merging system 106 can calculate an initial status 644 for the user account. For example, and as discussed in more detail below in FIG. 7, the data merging system 106 can determine if the user account is active, closed, delinquent, new, reopened, written off, written off but balance paid, or deleted.

As further shown in FIG. 6, once the data merging system 106 calculates the initial status 644 of the user account, the data merging system 106 can generate a staging with the account status 646. For instance, the data merging system 106 can add a column to the first stage 642 of the data staging table indicating the status of the user account. Based on the account status and the basic information associated with the user account, the data merging system 106 can determine which user accounts should be reported to third-party systems (e.g., credit bureaus) via the unscrubbed Metro2 file. In particular, the data merging system 106 can determine an initial member selection 648 for reporting by considering the data frame for opt out accounts 634, the data frame for account info 636, and the account status. For example, based on data frame for opt out accounts 634 indication that the user account should be excluded from reporting, the data merging system 106 will not select the user account for reporting via the unscrubbed Metro2 file and will not generate a data staging table 656 for the user account.

As further illustrated in FIG. 6, the data merging system 106 can generate a staging with member selection 650. In some cases, based on selecting the user account for reporting, the data merging system 106 can include a column indicating that the user account will be reported. In some instances, once the data merging system 106 generates the staging with member selection 650, the data merging system 106 can include PII 652 in the data staging table. For example, the data merging system 106 can generate a staging with PII 654. In particular, the data merging system 106 can include PII in the data staging table 656. For example, the data merging system 106 can add social security numbers, addresses, driver's license numbers, or PRNs from the data frame for PII data 638 to the staging with member selection 650. As shown in FIG. 6, once the data merging system 106 generates the staging with PII 654, the data merging system 106 can generate the data staging table 656. In particular the data staging table 656 can include all of the data that will be reported according to Metro2 requirements. As discussed above, the data merging system 106 can perform a transformation framework export job 658 which transmits the data staging table 656 to the storage service system 664 where the data merging system 106 generates a CVS file 666 that corresponds to the data staging table 656.

As discussed above, the data merging system 106 can determine the status of a user account. FIG. 7 illustrates a data merging system 106 determining the status of the user account in accordance with one or more embodiments. As mentioned above, the data merging system 106 can determine the status of the user account and whether or not to report the status of the user account to one or more third-party systems (e.g., credit bureaus). For instance, as shown in FIG. 7, the data merging system 106 can recognize the opening of a user account 702. In one or more cases, when the data merging system 106 recognizes the opening of a user account 702, the data merging system 106 can place the newly opened account in a pre-reporting state because the user account is not associated with any transactions and is not funded. In some embodiments, based on the pre-reporting status, the data merging system 106 will not report the user account. For instance, if the data merging system 106 does not identify any activity of the user account, the data merging system 106 can close the user account. Based on closing the user account, the data merging system 106 will not report the user account.

As shown in FIG. 7, once the data merging system 106 detects a transaction with the user account or funding into the user account, the data merging system 106 can update the status of the user account. In particular, the data merging system 106 can update the status of the user account to from the pre-reporting status to a current status 704. In some embodiments, the user account has a current status 704 if it does not have an outstanding balance. As indicated above, the user account can maintain the current status 704 by paying off any outstanding balances (e.g., debts incurred) during the billing period. In some embodiments, the data merging system 106 can pay off the outstanding balance of the user account by receiving an indication of an authorized transaction. In some implementations, an authorized transaction can include an automatic funds transfer from a secured account to a credit account associated with the user account. In some embodiments, based on the authorized transaction, the data merging system 106 can request data related to the user account from multiple data sources as discussed above.

As further illustrated in FIG. 7, based on the transaction history of the user account, the data merging system 106 can further update the status of the user account. For instance, as shown in FIG. 7, if the user account has an outstanding (e.g., unpaid) balance for a first time period, the data merging system 106 can change the status of the user account from the current status 704 to a delinquent status 708. As further shown in FIG. 7, if the data merging system 106 detects the balance paid 726 for the user account with a delinquent status 708, the data merging system 106 can update the delinquent status 708 of the user account to a current status 704.

As further shown in FIG. 7, based on the outstanding balance after a second time period, the data merging system 106 can update the status of the user account to a written off status 712. In one or more implementations, the written off status 712 can indicate that a debt is seriously delinquent, and the inter-network facility system does not expect to receive payment on the debt. For example, a user account with an outstanding balance after a second time period (e.g., 83 days) would have a written off status 712 reported in the unscrubbed Metro2 file.

In some cases, the data merging system 106 can update the written off status 712 of the user account. In particular, after giving the written off status 712 to the user account, the data merging system 106 can identify a reconciliation of the outstanding balance for the user account and update the written off status 712 to a written off but balance paid status 720. For example, the data merging system 106 can recognize a paid balance, debt forgiveness, or balance collected for the outstanding balance for the user account. In some cases, based on recognizing the reconciliation of the outstanding balance, the data merging system 106 can update the written off status 712 to the written off but balance paid status 720. Relatedly, and as further shown in FIG. 7, once the data merging system 106 reports the written off but balance paid status 720 via the unscrubbed Metro2 file, the data merging system 106 can indicate that the user account should not be reported.

As discussed above, the data merging system 106 can determine and report a current status 704 for a user account. In some cases, the data merging system 106 can receive an indication from a client device closing the user account. In some embodiments, when the user account closes and one month has passed, the data merging system 106 can update the status of the user account from current status 704 to a closed status 730. In one or more implementations, after the data merging system 106 reports the closed status 730 of the user account via the unscrubbed Metro2 file, the data merging system 106 can indicate that the user account will no longer be reported to third-party systems.

In some embodiments, as shown in FIG. 7, the data merging system 106 can report a deleted status 734 for the user account. For example, in some cases where the data merging system 106 receives an indication of bankruptcy 706 related to a user account with either a current status 704 or a delinquent status 708, the data merging system 106 can delete the user account and report the deleted account via the unscrubbed Metro2 file. As further shown in FIG. 7, once the data merging system 106 reports the deleted status 734 of the user account, the data merging system 106 can indicate that the user account should no longer be reported to third-party systems.

In some embodiments, where fraud 710 affects the user account, the data merging system 106 can indicate that the user account was closed due to fraud 738. In certain implementations, once the data merging system 106 closes the user account due to fraud, the data merging system 106 will not report the status of the user account to third-party systems.

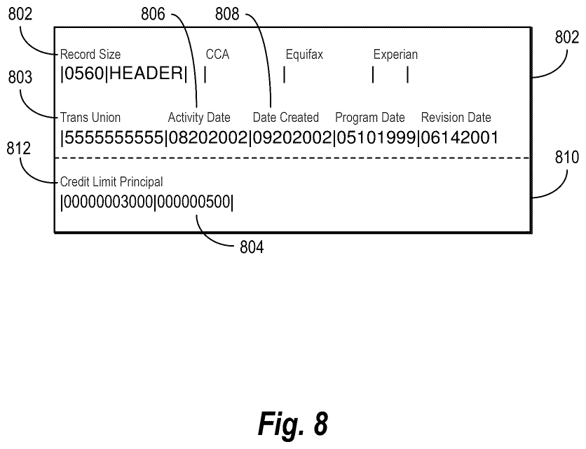

As mentioned above, the unscrubbed Metro2 file can report the credit information to one or more credit bureaus according to Metro2 format necessitated by the FCRA, FCBA, and ECOA. FIG. 8 illustrates an unscrubbed Metro2 file in accordance with one or more embodiments. As shown in FIG. 8, the unscrubbed Metro2 file 800 can include a header section 802. In one or more implementations, the header section 802 is the first segment of the unscrubbed Metro2 file and can include information identifying the reporting entity (e.g., inter-network facilitation system), third-party system (e.g., credit bureau), and/or the reporting date of the unscrubbed Metro2 file 800. For instance, as shown in FIG. 8, the header section 802 indicates that the data merging system 106 reported the unscrubbed Metro2 file 800 to the TransUnion 803 credit bureau. As further shown in FIG. 8, the header section 802 can include the activity date 806 indicating the date of the last update to the user account balance. In some embodiments, the header section 802 can include a date created field 808 indicating the date that the data merging system 106 generated the unscrubbed Metro2 file. In some cases, the header section 802 can include information about the name, address, and/or phone number of the inter-network facility system.

As further shown in FIG. 8, the unscrubbed Metro2 file 800 can include a base segment 810. In some cases, the base segment 810 is a second segment of the unscrubbed Metro2 file 800 and contains information that identifies a user corresponding to the user account and reflects transactional information associated with the user account. For example, as shown in FIG. 8, the base segment can include information about the credit limit 812 associated with the user account. For example, the credit limit for the user account can be three-thousand dollars. In one or more embodiments, the base segment 810 of the unscrubbed Metro2 file can include additional information as required by Metro2 file formatting such as, but not limited to, the account status, date the user account closed, date of last payment, social security number associated with the user account, etc.

In some embodiments, the unscrubbed Metro2 file can include additional segments such as a J1 segment, J2 segment, K1 segment, and/or trailer record. In some cases, the unscrubbed Metro2 file includes the J1 segment if the reported user account has a cosigner that resides at the same address as the user of user account. In some cases, the unscrubbed Metro2 file can include a J2 segment if the reported user account has a cosigner that resides at a different address than the user being reported. In one or more cases, the unscrubbed Metro2 file can include K1 segment include information about the original creditor if the account is reported by a third party (e.g., collection agency, debt collector, factoring companies, etc.). In some cases, the unscrubbed Metro2 file includes a trailer record that reflects cumulative totals of all the records, segments and Metro2 status codes of one or more user accounts within the inter-network facilitation system 104.

Turning now to FIG. 9, this figure shows a flowchart of a series of acts 900 for generating an unscrubbed Metro2 file in accordance with one or more implementations. While FIG. 9 illustrates acts according to one embodiment, alternative embodiments may omit, add to, reorder, and/or modify any of the acts shown in FIG. 9. The acts of FIG. 9 can be performed as part of a method. Alternatively, a non-transitory computer readable storage medium can comprise instructions that, when executed by the one or more processors, cause a computing device to perform the acts depicted in FIG. 9. In still further embodiments, a system can perform the acts of FIG. 9.

As shown in FIG. 9, the series of acts 900 include an act 902 of receiving data related to a user account. For example, the act 902 can include receiving, from multiple data sources, data related to a user account of an inter-network facilitation system.

As shown in FIG. 9, the series of acts 900 can include an act 904 of generating a staging table by merging the data related to the user account. For instance, the act 904 can include generating a data staging table by merging the data related to the user account of the inter-network facilitation system from the multiple data sources utilizing a transformation framework.

As also shown in FIG. 9, the series of acts 900 can include an act 906 of generating a scrubbed Metro2 file based on the data staging table. For example, the act 906 can include generating, based on the data staging table, a scrubbed Metro2 file that comprises the data related to the user account but does not include personal identification information.

As shown in FIG. 9, the series of acts 900 can include an act 908 of validating the scrubbed Metro2 file. For instance, the act 908 can include validating the scrubbed Metro2 file by analyzing the data related to the user account.

As further shown in FIG. 9, the series of acts 900 can include an act 910 of generating an unscrubbed Metro2 file. In particular, the act 910 can include based upon validating the scrubbed Metro2 file, generating an unscrubbed Metro2 file by adding the personal identification information to the scrubbed Metro2 file.

In some embodiments, the series of acts can include an act where merging the data related to the user account of the inter-network facilitation system from the multiple data sources further comprises: generating one or more base tables from the multiple data sources; generating a set of data frames from the one or more base tables by performing a set of queries on the one or more base tables; and merging the set of data frames according to a predefined order of steps.

In one or more implementations the series of acts 900 can include validating the set of data frames by applying one or more validation scripts to the set of data frames. Additionally, the series of acts 900 can include an act where the one or more validation scripts comprises: a trend script, record comparison script, or logic script.

In some cases, the series of acts 900 can include generating an intermediate instance of the scrubbed Metro2 file by converting the data staging table into a corresponding CVS file. In one or more embodiments, the series of acts 900 can include encrypting a final instance of the unscrubbed Metro2 file; and sending an encrypted unscrubbed Metro2 file to a third-party system.

In one or more implementations, the series of acts 900 can include receiving an indication of an authorized transaction; and based on the authorized transaction, requesting the data related to the user account of the inter-network facilitation system from the multiple data sources. In some cases, the series of acts 900 can include an act where the authorized transaction is an automatic funds transfer from a secured account to a credit account.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 10 illustrates, in block diagram form, an exemplary computing device 1000 that may be configured to perform one or more of the processes described above. One will appreciate that the data merging system 106 (or the inter-network facilitation system 104) can comprise implementations of a computing device 1000, including, but not limited to, the devices or systems illustrated in the previous figures. As shown by FIG. 10, the computing device can comprise a processor 1002, memory 1004, a storage device 1006, an I/O interface 1008, and a communication interface 1010. In certain embodiments, the computing device 1000 can include fewer or more components than those shown in FIG. 10. Components of computing device 1000 shown in FIG. 10 will now be described in additional detail.

In particular embodiments, processor(s) 1002 includes hardware for executing instructions, such as those making up a computer program. As an example, and not by way of limitation, to execute instructions, processor(s) 1002 may retrieve (or fetch) the instructions from an internal register, an internal cache, memory 1004, or a storage device 1006 and decode and execute them.

The computing device 1000 includes memory 1004, which is coupled to the processor(s) 1002. The memory 1004 may be used for storing data, metadata, and programs for execution by the processor(s). The memory 1004 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 1004 may be internal or distributed memory.

The computing device 1000 includes a storage device 1006 includes storage for storing data or instructions. As an example, and not by way of limitation, storage device 1006 can comprise a non-transitory storage medium described above. The storage device 1006 may include a hard disk drive (“HDD”), flash memory, a Universal Serial Bus (“USB”) drive or a combination of these or other storage devices.

The computing device 1000 also includes one or more input or output (“I/O”) interface 1008, which are provided to allow a user (e.g., requester or provider) to provide input to (such as user strokes), receive output from, and otherwise transfer data to and from the computing device 1000. These I/O interface 1008 may include a mouse, keypad or a keyboard, a touch screen, camera, optical scanner, network interface, modem, other known I/O devices or a combination of such I/O interface 1008. The touch screen may be activated with a stylus or a finger.

The I/O interface 1008 may include one or more devices for presenting output to a user, including, but not limited to, a graphics engine, a display (e.g., a display screen), one or more output providers (e.g., display providers), one or more audio speakers, and one or more audio providers. In certain embodiments, the I/O interface 1008 is configured to provide graphical data to a display for presentation to a user. The graphical data may be representative of one or more graphical user interfaces and/or any other graphical content as may serve a particular implementation.

The computing device 1000 can further include a communication interface 1010. The communication interface 1010 can include hardware, software, or both. The communication interface 1010 can provide one or more interfaces for communication (such as, for example, packet-based communication) between the computing device and one or more other computing devices 1000 or one or more networks. As an example, and not by way of limitation, communication interface 1010 may include a network interface controller (“NIC”) or network adapter for communicating with an Ethernet or other wire-based network or a wireless NIC (“WNIC”) or wireless adapter for communicating with a wireless network, such as a WI-FI. The computing device 1000 can further include a bus 1012. The bus 1012 can comprise hardware, software, or both that couples components of computing device 1000 to each other.

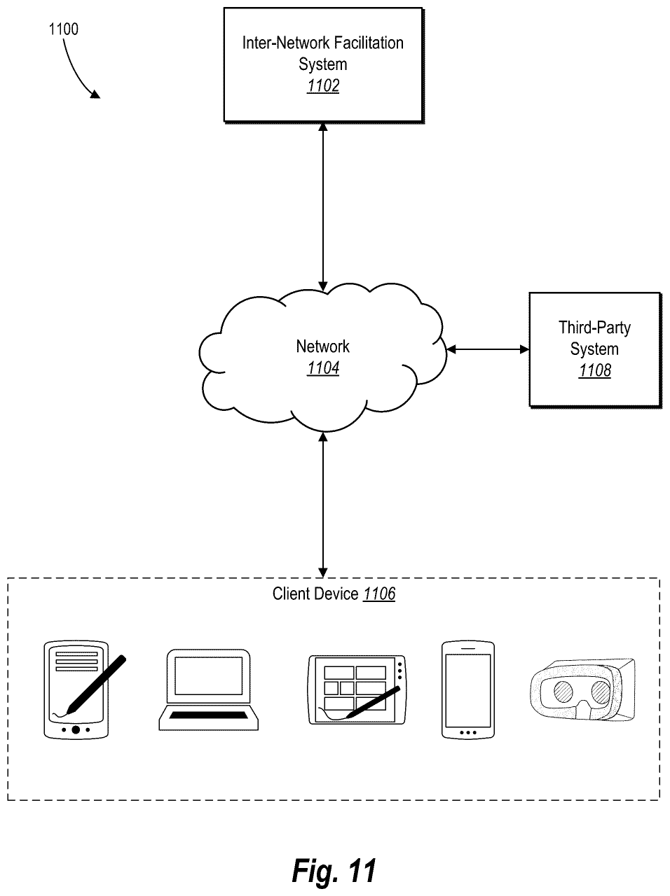

FIG. 11 illustrates an example network environment 1100 of the inter-network facilitation system 104. The network environment 1100 includes a client device 1106 (e.g., client devices 112a-112n and/or an administrator device 116), an inter-network facilitation system 104, and a third-party system 1108 connected to each other by a network 1104. Although FIG. 11 illustrates a particular arrangement of the client device 1106, the inter-network facilitation system 104, the third-party system 1108, and the network 1104, this disclosure contemplates any suitable arrangement of client device 1106, the inter-network facilitation system 104, the third-party system 1108, and the network 1104. As an example, and not by way of limitation, two or more of client device 1106, the inter-network facilitation system 104, and the third-party system 1108 communicate directly, bypassing network 1104. As another example, two or more of client device 1106, the inter-network facilitation system 104, and the third-party system 1108 may be physically or logically co-located with each other in whole or in part.

Moreover, although FIG. 11 illustrates a particular number of client devices 1106, inter-network facilitation systems 104, third-party systems 1108, and networks 1104, this disclosure contemplates any suitable number of client devices 1106, inter-network facilitation system 104, third-party systems 1108, and networks 1104. As an example, and not by way of limitation, network environment 1100 may include multiple client devices 1106, inter-network facilitation system 104, third-party systems 1108, and/or networks 1104.

This disclosure contemplates any suitable network 1104. As an example, and not by way of limitation, one or more portions of network 1104 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 1104 may include one or more networks 1104.

Links may connect client device 1106, inter-network facilitation system 104 (e.g., which hosts the data merging system 106), and third-party system 1108 to network 1104 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1100. One or more first links may differ in one or more respects from one or more second links.

In particular embodiments, the client device 1106 may be an electronic device including hardware, software, or embedded logic components or a combination of two or more such components and capable of carrying out the appropriate functionalities implemented or supported by client device 1106. As an example, and not by way of limitation, a client device 1106 may include any of the computing devices discussed above in relation to FIG. 10. A client device 1106 may enable a network user at the client device 1106 to access network 1104. A client device 1106 may enable its user to communicate with other users at other client devices 1106.

In particular embodiments, the client device 1106 may include a requester application or a web browser, such as MICROSOFT INTERNET EXPLORER, GOOGLE CHROME, or MOZILLA FIREFOX, and may have one or more add-ons, plug-ins, or other extensions, such as TOOLBAR or YAHOO TOOLBAR. A user at the client device 1106 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 1106 one or more Hyper Text Markup Language (“HTML”) files responsive to the HTTP request. The client device 1106 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, inter-network facilitation system 104 may be a network-addressable computing system that can interface between two or more computing networks or servers associated with different entities such as financial institutions (e.g., banks, credit processing systems, ATM systems, or others). In particular, the inter-network facilitation system 104 can send and receive network communications (e.g., via the network 1104) to link the third-party-system 1108. For example, the inter-network facilitation system 104 may receive authentication credentials from a user to link a third-party system 1108 such as an online bank account, credit account, debit account, or other financial account to a user account within the inter-network facilitation system 104. The inter-network facilitation system 104 can subsequently communicate with the third-party system 1108 to detect or identify balances, transactions, withdrawal, transfers, deposits, credits, debits, or other transaction types associated with the third-party system 1108. The inter-network facilitation system 104 can further provide the aforementioned or other financial information associated with the third-party system 1108 for display via the client device 1106. In some cases, the inter-network facilitation system 104 links more than one third-party system 1108, receiving account information for accounts associated with each respective third-party system 1108 and performing operations or transactions between the different systems via authorized network connections.

In particular embodiments, the inter-network facilitation system 104 may interface between an online banking system and a credit processing system via the network 1104. For example, the inter-network facilitation system 104 can provide access to a bank account of a third-party system 1108 and linked to a user account within the inter-network facilitation system 104. Indeed, the inter-network facilitation system 104 can facilitate access to, and transactions to and from, the bank account of the third-party system 1108 via a client application of the inter-network facilitation system 104 on the client device 1106. The inter-network facilitation system 104 can also communicate with a credit processing system, an ATM system, and/or other financial systems (e.g., via the network 1104) to authorize and process credit charges to a credit account, perform ATM transactions, perform transfers (or other transactions) across accounts of different third-party systems 1108, and to present corresponding information via the client device 1106.

In particular embodiments, the inter-network facilitation system 104 includes a model for approving or denying transactions. For example, the inter-network facilitation system 104 includes a transaction approval machine learning model that is trained based on training data such as user account information (e.g., name, age, location, and/or income), account information (e.g., current balance, average balance, maximum balance, and/or minimum balance), credit usage, and/or other transaction history. Based on one or more of these data (from the inter-network facilitation system 104 and/or one or more third-party systems 1108), the inter-network facilitation system 104 can utilize the transaction approval machine learning model to generate a prediction (e.g., a percentage likelihood) of approval or denial of a transaction (e.g., a withdrawal, a transfer, or a purchase) across one or more networked systems.

The inter-network facilitation system 104 may be accessed by the other components of network environment 1100 either directly or via network 1104. In particular embodiments, the inter-network facilitation system 104 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by the server. In particular embodiments, the inter-network facilitation system 104 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 1106, or an inter-network facilitation system 104 to manage, retrieve, modify, add, or delete, the information stored in a data store.

In particular embodiments, the inter-network facilitation system 104 may provide users with the ability to take actions on various types of items or objects, supported by the inter-network facilitation system 104. As an example, and not by way of limitation, the items and objects may include financial institution networks for banking, credit processing, or other transactions, to which users of the inter-network facilitation system 104 may belong, computer-based applications that a user may use, transactions, interactions that a user may perform, or other suitable items or objects. A user may interact with anything that is capable of being represented in the inter-network facilitation system 104 or by an external system of a third-party system, which is separate from inter-network facilitation system 104 and coupled to the inter-network facilitation system 104 via a network 1104.

In particular embodiments, the inter-network facilitation system 104 may be capable of linking a variety of entities. As an example, and not by way of limitation, the inter-network facilitation system 104 may enable users to interact with each other or other entities, or to allow users to interact with these entities through an application programming interfaces (“API”) or other communication channels.

In particular embodiments, the inter-network facilitation system 104 may include a variety of servers, sub-systems, programs, modules, logs, and data stores. In particular embodiments, the inter-network facilitation system 104 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The inter-network facilitation system 104 may also include suitable components such as network interfaces, security mechanisms, load balancers, failover servers, management-and-network-operations consoles, other suitable components, or any suitable combination thereof. In particular embodiments, the inter-network facilitation system 104 may include one or more user-profile stores for storing user profiles for transportation providers and/or transportation requesters. A user profile may include, for example, biographic information, demographic information, financial information, behavioral information, social information, or other types of descriptive information, such as interests, affinities, or location.

The web server may include a mail server or other messaging functionality for receiving and routing messages between the inter-network facilitation system 104 and one or more client devices 1106. An action logger may be used to receive communications from a web server about a user's actions on or off the inter-network facilitation system 104. In conjunction with the action log, a third-party-content-object log may be maintained of user exposures to third-party-content objects. A notification controller may provide information regarding content objects to a client device 1106. Information may be pushed to a client device 1106 as notifications, or information may be pulled from client device 1106 responsive to a request received from client device 1106. Authorization servers may be used to enforce one or more privacy settings of the users of the inter-network facilitation system 104. A privacy setting of a user determines how particular information associated with a user can be shared. The authorization server may allow users to opt in to or opt out of having their actions logged by the inter-network facilitation system 104 or shared with other systems, such as, for example, by setting appropriate privacy settings. Third-party-content-object stores may be used to store content objects received from third parties. Location stores may be used for storing location information received from client devices 1106 associated with users.

In addition, the third-party system 1108 can include one or more computing devices, servers, or sub-networks associated with internet banks, central banks, commercial banks, retail banks, credit processors, credit issuers, ATM systems, credit unions, loan associates, brokerage firms, linked to the inter-network facilitation system 104 via the network 1104. A third-party system 1108 can communicate with the inter-network facilitation system 104 to provide financial information pertaining to balances, transactions, and other information, whereupon the inter-network facilitation system 104 can provide corresponding information for display via the client device 1106. In particular embodiments, a third-party system 1108 communicates with the inter-network facilitation system 104 to update account balances, transaction histories, credit usage, and other internal information of the inter-network facilitation system 104 and/or the third-party system 1108 based on user interaction with the inter-network facilitation system 104 (e.g., via the client device 1106). Indeed, the inter-network facilitation system 104 can synchronize information across one or more third-party systems 1108 to reflect accurate account information (e.g., balances, transactions, etc.) across one or more networked systems, including instances where a transaction (e.g., a transfer) from one third-party system 1108 affects another third-party system 1108.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
receiving, from multiple data sources, data related to a user account of an inter-network facilitation system;
generating a data staging table by merging the data related to the user account of the inter-network facilitation system from the multiple data sources utilizing a transformation framework;
generating, based on the data staging table, a scrubbed Metro2 file that comprises the data related to the user account but does not include personal identification information;
validating the scrubbed Metro2 file by analyzing the data related to the user account; and
based upon validating the scrubbed Metro2 file, generating an unscrubbed Metro2 file by adding the personal identification information to the scrubbed Metro2 file.

2. The computer-implemented method of claim 1 wherein merging the data related to the user account of the inter-network facilitation system from the multiple data sources further comprises:
generating one or more base tables from the multiple data sources;
generating a set of data frames from the one or more base tables by performing a set of queries on the one or more base tables; and
merging the set of data frames according to a predefined order of steps.

3. The computer-implemented method of claim 2, further comprising:
validating the set of data frames by applying one or more validation scripts to the set of data frames.

4. The computer-implemented method of claim 3, wherein the one or more validation scripts comprises: a trend script, record comparison script, or logic script.

5. The computer-implemented method of claim 1, further comprising:
generating an intermediate instance of the scrubbed Metro2 file by converting the data staging table into a corresponding CVS file.

6. The computer-implemented method of claim 1, further comprising:
encrypting a final instance of the unscrubbed Metro2 file; and
sending an encrypted unscrubbed Metro2 file to a third-party system.

7. The computer-implemented method of claim 1, further comprising:
receiving an indication of an authorized transaction; and
based on the authorized transaction, requesting the data related to the user account of the inter-network facilitation system from the multiple data sources.

8. The computer-implemented method of claim 7, wherein the authorized transaction is an automatic funds transfer from a secured account to a credit account.

9. A non-transitory computer-readable medium storing instructions that, when executed by at least one processor, cause a computing device to:
receive, from multiple data sources, data related to a user account of an inter-network facilitation system;
generate a data staging table by merging the data related to the user account of the inter-network facilitation system from the multiple data sources utilizing a transformation framework;
generate, based on the data staging table, a scrubbed Metro2 file that comprises the data related to the user account but does not include personal identification information;
validate the scrubbed Metro2 file by analyzing the data related to the user account; and
based upon validating the scrubbed Metro2 file, generate an unscrubbed Metro2 file by adding the personal identification information to the scrubbed Metro2 file.

10. The non-transitory computer-readable medium of claim 9, wherein merging the data related to the user account of the inter-network facilitation system from the multiple data sources further comprises:
generating one or more base tables from the multiple data sources;
generating a set of data frames from the one or more base tables by performing a set of queries on the one or more base tables; and
merging the set of data frames according to a predefined order of steps.

11. The non-transitory computer-readable medium of claim 10, further comprising instructions that, when executed by the at least one processor, cause the computing device to:
validate the set of data frames by applying one or more validation scripts to the set of data frames.

12. The non-transitory computer-readable medium of claim 11, wherein the one or more validation scripts comprises: a trend script, record comparison script, or logic script.

13. The non-transitory computer-readable medium of claim 9, further comprising instructions that, when executed by the at least one processor, cause the computing device to:
generate an intermediate instance of the scrubbed Metro2 file by converting the data staging table into a corresponding CVS file.

14. The non-transitory computer-readable medium of claim 9, further comprising instructions that, when executed by the at least one processor, cause the computing device to:
encrypting a final instance of the unscrubbed Metro2 file; and
sending an encrypted unscrubbed Metro2 file to a third-party system.

15. The non-transitory computer-readable medium of claim 9, further comprising instructions that, when executed by the at least one processor, cause the computing device to:
receive an indication of an authorized transaction; and
based on the authorized transaction, request the data related to the user account of the inter-network facilitation system from the multiple data sources.

16. The non-transitory computer-readable medium of claim 15, wherein the authorized transaction is an automatic funds transfer from a secured account to a credit account.

17. A system comprising:
at least one processor; and
at least one non-transitory computer-readable storage medium storing instructions that, when executed by the at least one processor, cause the system to:
receive, from multiple data sources, data related to a user account of an inter-network facilitation system;
generate a data staging table by merging the data related to the user account of the inter-network facilitation system from the multiple data sources utilizing a transformation framework;
generate, based on the data staging table, a scrubbed Metro2 file that comprises the data related to the user account but does not include personal identification information;
validate the scrubbed Metro2 file by analyzing the data related to the user account; and
based upon validating the scrubbed Metro2 file, generate an unscrubbed Metro2 file by adding the personal identification information to the scrubbed Metro2 file.

18. The system of claim 17, wherein merging the data related to the user account of the inter-network facilitation system from the multiple data sources further comprises:
generating one or more base tables from the multiple data sources;
generating a set of data frames from the one or more base tables by performing a set of queries on the one or more base tables; and
merging the set of data frames according to a predefined order of steps.

19. The system of claim 18, further comprising instructions that, when executed by the at least one processor, cause the system to:
validate the set of data frames by applying one or more validation scripts to the set of data frames.

20. The system of claim 19, wherein the one or more validation scripts comprises: a trend script, record comparison script, or logic script.
